(19) United States
(12) Patent Application Publication
(10) Pub. No.: US 2009/0071415 A1
(43) Pub. Date: Mar. 19, 2009

(54) Veterinary gurney or table incorporating a removable dental tray

(76) Inventor: Frank Jehn, Toms River, NJ (US)

Correspondence Address: CLIFFORD G. FRAYNE, Suite 7A, 136 Drum Point Road, Brick, NJ, 08723, US

(21) Appl. No.: 12/077,754

(22) Filed: Mar. 24, 2008

Related U.S. Application Data
(60) Provisional application No. 60/919,880, filed on Mar. 26, 2007.

(51) Int. Cl. A61G 13/00; A61G 13/06; B62B 3/02; B62B 11/00; A61G 13/12

(52) U.S. Cl. 119/753; 280/651

(57) ABSTRACT

A veterinary gurney or table having a base frame member supporting a mobility means, an elevation frame member mounted on the base frame, and a table member mounted on the elevation frame, allowing the elevation of the gurney or table to be locked at a selected height, one end of the gurney or table adapted to receive a slidable, securable dental tray for dental treatment of the animal while positioned on the gurney or table.

### RELATED APPLICATIONS

Applicant claims the benefit of provisional application Ser. No. 60/919,880, filed Mar. 26, 2007.

### BACKGROUND OF THE INVENTION

1. Field of the Invention

The present invention relates to gurneys and in particular to a veterinary gurney or veterinary table allowing the user to adjust to any selected height between fully collapsed and fully extended for the transport, transfer or examination of an animal and in particular to perform dental treatment on an animal.

2. Description of the Prior Art

Gurneys are well known in the prior art for the transfer of humans from an accident scene to an ambulance to a hospital or emergency room. Gurneys are also used in the veterinary science to treat animals and to transfer animals within the veterinary such as from a cage to the operating table or vice versa. The veterinarian however treats animals of varying size, shape and weight. Therefore the veterinary gurney must easily accommodate various size animals and must also be able to be positioned at a selected height to transfer and treat animals and be collapsible for storage when not in use. In a veterinary clinic, animals may be housed or recuperate in cages or enclosures of varying heights from the floor. They may also be treated at various locations within the veterinary which are at different heights. It is therefore an advantage to be able to adjust the table top associated with the gurney to this preselected height, as well as adjust the height of a fixed veterinary table. Applicant is the holder of U.S. Pat. No. 6,684,424 for a veterinary gurney of the type described which Applicant hereby incorporates herein as if set forth at length and in detail.

The veterinary gurney is a multi-use piece of equipment and many times treatment of the animal occurs on the gurney as opposed to the wet table or operating table. It would therefore be advantageous if the veterinary gurney or fixed veterinary table could be adopted to allow for dental treatment of the animal. A veterinary gurney susceptible to this adaptation would be Applicant's gurney as disclosed in U.S. Pat. No. 6,684,424, which is incorporated herein by reference.

### OBJECTS OF THE INVENTION

An object of the present invention is to provide for a novel veterinary gurney or veterinary table which can be locked at infinitely selectable heights between the fully collapsed position and the fully extended position and adapt to a removable dental tray for dental treatment of the animal.

Another object of the present invention is to provide for a novel veterinary gurney or veterinary table in which the gurney or table is receptive to a slidably attached and securable dental tray for dental treatment of the animal.

### SUMMARY OF THE INVENTION

A veterinary gurney or table having a base frame member supporting a mobility means, an elevation frame member mounted on the base frame, and a table member mounted on the elevation frame, allowing the elevation of the gurney or table to be locked at a selected height, one end of the gurney or table adapted to receive a slidable, securable dental tray for dental treatment of the animal while positioned on the gurney or table.

### BRIEF DESCRIPTION OF THE DRAWINGS

These and other objects of the present invention will become evident, particularly when taken in light of the following illustrations wherein:

FIG. 1 is a side view of a veterinary gurney;

FIG. 2 is a top view of an end of a veterinary gurney with dental tray;

FIG. 3 is a side view of an end of a veterinary gurney with dental tray;

FIG. 4 is a bottom view of a veterinary gurney with dental tray;

FIG. 5 is a top view of an end of a veterinary gurney with a second embodiment of the dental tray;

FIG. 6 is a top view of an end of a veterinary gurney of FIG. 5 with a third embodiment of the dental tray;

FIG. 7 is a side view of an embodiment of the veterinary gurney and first, second, or third embodiment of the dental tray incorporating a drain; and

FIG. 8 is a top view of a fourth embodiment of the veterinary gurney and dental tray.

### DETAILED DESCRIPTION OF THE DRAWINGS

The present invention is adaptable to a mobile veterinary gurney or a fixed veterinary table in which the table top supports an animal or pet. The present invention functions in the same manner on either the gurney or table and will be described with respect to a veterinary gurney.

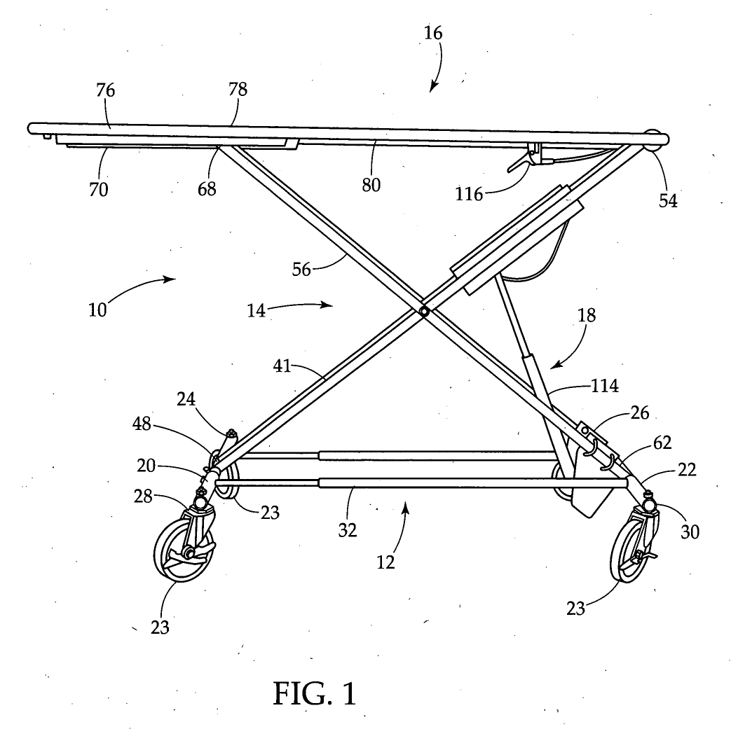

FIG. 1 is a side view of a veterinary gurney 10 of the present invention, which would be susceptible to allowing the use of a dental tray. The veterinary gurney 10 of the present invention comprises four main elements; a base frame 12, a scissor frame 14, a gurney table member 16, and an elevational assist and lock member 18.

Base frame member 12 is constructed of two parallel, spaced apart axle members 20 and 22 having first ends 24 and 26 respectively, and second ends 28 and 30. Parallel spaced apart axle members 20 and 22 are secured together by means of two parallel extender telescopic rods 31 and 32. Secured at the ends of parallel spaced apart axle members 20 and 22 are swivel lock wheels 23 which provide mobility to the veterinary gurney 10.

Scissor frame 14 is comprised of a first frame member 41 having two tubular members in fixed parallel relationship. The cross tube 48 is positioned on axle 20 between extender rods 30 and 32. The second ends of the first frame member are secured to a second cross tube 54 which is rotatably secured to the gurney table member 16.

Second scissor frame member 56 is comprised of two parallel fixed tubes, the first ends being secured to a cross member 62 which is rotatably mounted on axle member 22 between extender rods 31 and 32. The second end of parallel fixed tubes of second scissor frame member 56 are secured to a cross tube 68 which is slidably receivable within a track guide 70 mounted on the underside 80 of gurney table member 16.

The gurney table member 16 comprises a rigid planar member 76 having an upper surface 78 and a lower surface 80, the gurney table top being mounted to a tubular frame about the gurney table member periphery.

The elevation assist member 18 comprises a gas pressurized cylinder 114 in communication with a toggle switch 116, mounted on gurney table member 16. The elevational assist member 18 allows the user by means of toggle switch 116 to raise and lower the veterinary gurney to a desired height, and to further allow the complete collapse of the veterinary gurney if so desired.

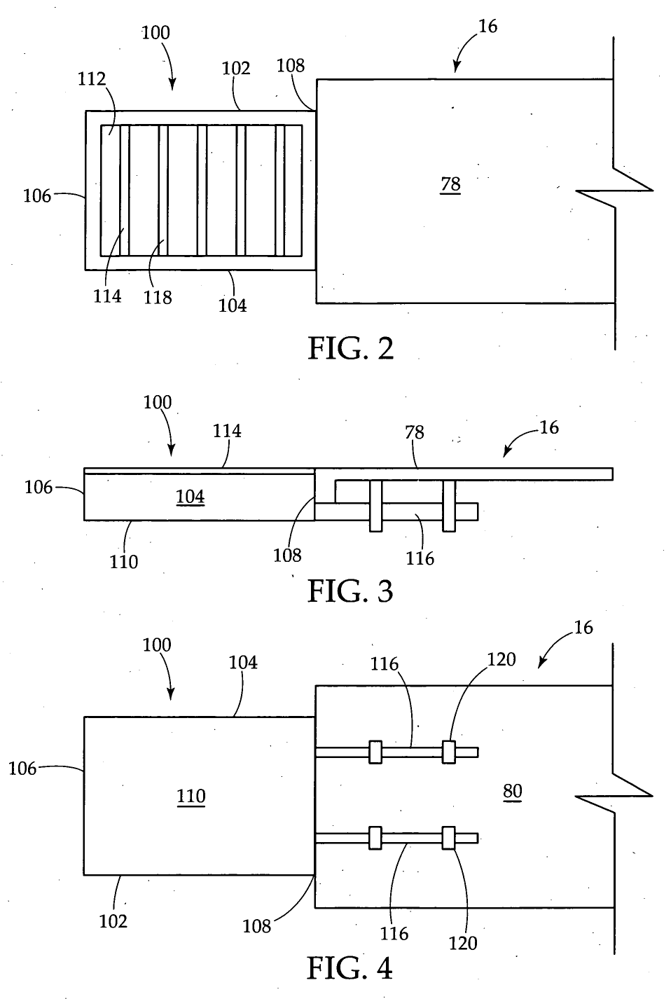

FIG. 2 is a top view of a first embodiment of dental tray member 100 and is secured to veterinary gurney 10; FIG. 4 is a bottom view of dental tray 100 secured to veterinary gurney 10; FIG. 3 is a side view of dental tray 100 secured to veterinary gurney 10.

Veterinary dental tray 100 comprises a geometrically shaped tray having opposing side walls 102 and 104, a front wall 106, an end wall 108, and a bottom wall 110, defining a cavity 112 covered by a grid 114. Dental tray 100 has a plurality of extension fingers 116 which extend outwardly from dental tray 100 and below the upper surface 78 of veterinary gurney 10 such that the grid 114 is in the same plane as the upper surface 78 of veterinary gurney 10 when dental tray 100 is removably secured thereto.

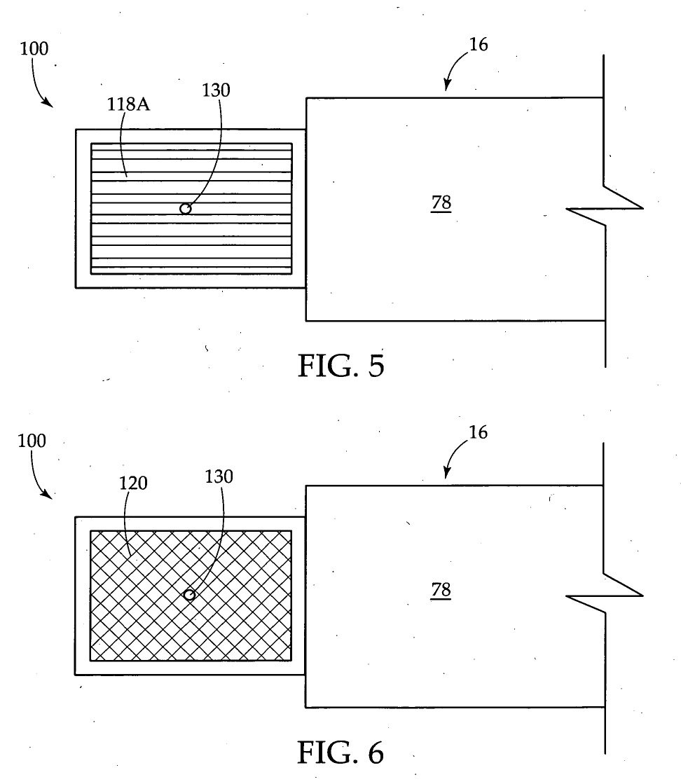

The grid 114 of dental tray 100 may comprise a plurality of horizontal parallel support bars 118 perpendicular to the longitudinal axis of veterinary gurney 10 (FIG. 1) or a plurality of horizontal support bars 118A in alignment with the longitudinal axis of veterinary gurney 10 (FIG. 5) or a series of vertical and horizontal intersecting support bars 120 (FIG. 6) for support of the snout of an animal resting on the veterinary gurney support table 10. The grid 114 of dental tray 100 may also be in the form of a plate 121 having a plurality of apertures 123 there through (FIG. 8).

In one embodiment, the dental support tray 100 is slidably receivably secured to the veterinary gurney 10 by a plurality of support extension fingers 116 slidably receivable on the lower surface 80 of the veterinary gurney 10 by means of finger receptacles 120 which frictionally engage the slidably receivable extension fingers 116 thus allowing the dental tray 100 to be positioned in abuttable relationship with the end of veterinary gurney 10 and for the grid 114 to be in planar relationship with the upper surface 78 of veterinary gurney 10.

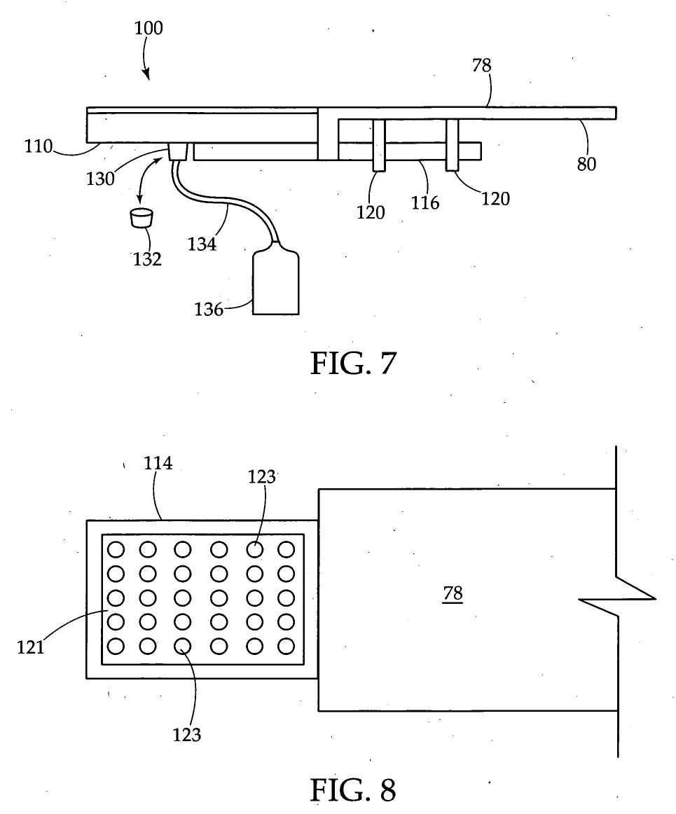

FIG. 5 is a top view of a second embodiment of the dental tray 100 which incorporates a drain member 130 should the dental procedure be one of extended time, and FIG. 7 is a side view of the second embodiment. In this situation, a drain member 130 formed in the bottom wall 110 of the dental tray 100 would be formed with a cap member 132 in accordance with the first embodiment as described in FIGS. 2, 3, and 4. If the dental procedure were to be extended, the cap member 132 could be removed and a flexible conduit 134 could be secured to the drain member 130 and extend to a receptacle container 136 for collection of water, detritus, etc. In this embodiment, the bottom wall 110 of dental tray 100 would be sloped downwardly in the direction of drain member 130 to aid in the evacuation of fluids and detritus.

FIG. 8 is a third embodiment of the dental tray 100 in which the grid 114 comprises a plate 121 having a plurality of apertures 123 there through in communication with cavity 112.

In operation, the animal would be positioned on the veterinary gurney 10 with its snout positioned over the grid 114 of the dental tray 100. The veterinarian could then position himself on a seat proximate the dental tray 100 and have access to the mouth and teeth of the animal which would be positioned on the grid 114 of dental tray 100. The veterinarian could then scale and/or perform what other operations were required on the teeth and the mouth of the animal utilizing appropriate utensils and a water spray which would be collected in the cavity 112 of the dental tray 100. In the situation where significant detritus and water might be collected, the dental tray 100 would have the aforementioned drain member 130 and flexible conduit 134 to a receptacle container 136 as described in embodiment 2 so as to remove the water and detritus while the oral procedure continues.

The dental tray would be formed of appropriate surgical material such as stainless steel or the like so that in either of the embodiments it could be removed from the veterinary gurney 10 and cleaned and sterilized for further use. Additionally, grid 114 in all embodiments would be removable from dental tray 100 to aid in cleaning and sterilizing.

The advantage of this dental tray is that when combined with a surgical table of the type described, which allows for the veterinarian or assistant to adjust the height of the table to a specific height, the dental tray is at a level sufficient and available to the veterinarian or the assistant to perform the appropriate dental procedure to the animal involved in a relaxed and accommodating posture.

While the dental tray in combination with the veterinary gurney 10 has been described with respect to its connection to the table by means of extension fingers which are slidably, frictionally engagable with the underside of the table, it will be recognized by those of ordinary skill in the art that the dental tray can be secured removably to the table by other means without departing from the scope and configuration thus described.

While the present invention has been described with respect to the preferred embodiment thereof, it will be recognized by those of ordinary skill in the art that many changes and modifications may be made without departing from the spirit and scope of the invention.

I claim:

1. A veterinary gurney for the transport of an animal, the height of said gurney selectively adjustable to a height between fully collapsed to fully extended, the gurney incorporating a slidably removable dental tray for dental treatment of an animal so positioned, said gurney comprising:
a horizontal support having a first end and a second end, an upper support surface and a lower support surface, said lower support surface having a pair of parallel disposed rails proximate said first end;
a base frame having a first axle member and a second axle member in parallel, spaced apart relationship, said first axle member disposed beneath said first end of said horizontal support, said second axle member disposed beneath said second end of said horizontal support, said first and second axle members having a pair of wheels swivelly mounted thereon, there being disposed between said two spaced apart axle members, two parallel spaced apart telescoping extender rods, the opposing ends of which are secured to said first and second axle members;
an elevational scissor frame rotatably secured to said base frame and fixedly and slidably mounted to said horizontal support, said scissor frame comprising a rotatable sleeve member mounted on each axle member, a first pair of arms paralleledly disposed having first end secured to said sleeve member on said first axle member, and second ends fixedly secured to said lower surface of said horizontal support at said second end of said horizontal support;
an elevation and locking means mounted to said base member between said second pair of arms said scissor means, in communication with said first pair of arms providing means for elevation to selected height, locking at a selected height and means for collapse, said elevational and locking means comprising a pressurized cylinder activated by a power activation means positioned on said lower support surface of said horizontal support, said pressurized cylinder is secured to said base frame below said second axle member to permit collapse of said gurney;
a dental tray removably, frictionally secured to said first end of said gurney, said dental tray defined by side walls and a bottom wall, and an upper wall comprised of a removable grid, said dental tray removably secured to said lower support surface of said horizontal support so as to position said upper wall and removable grid in the plane of the upper support surface of said horizontal support.

2. The veterinary gurney for the transport of an animal in accordance with claim 1, the height of said gurney selectively adjustable to a height between fully collapsed to fully extended wherein said gurney incorporates a dental tray, said dental tray further comprising a drain port positioned in said bottom wall, said drain port for the receipt of a flexible conduit in communication with a waste reservoir.

3. The veterinary gurney for transport of an animal in accordance with claim 1 wherein said dental tray grid comprises a grill of intersecting wire for the support of the snout of an animal.

4. The veterinary gurney for transport of an animal in accordance with claim 1 wherein said dental tray grid comprises a grill having a plurality of apertures there through for the support of a snout of said animal.

5. The veterinary gurney for transport of an animal in accordance with claim 1 wherein said dental tray and said grid are removable from said veterinary gurney and said grid and said dental tray are separable for cleaning and disinfecting.
